(19) United States
(12) Patent Application Publication
(10) Pub. No.: US 2004/0110871 A1
(43) Pub. Date: Jun. 10, 2004

(54) Method for obtaining solid particles from at least a water soluble product

(76) Inventors: Michel Perrut, Nancy (FR); Jennifer Jung, Nancy (FR); Fabrice Leboeuf, Saint-Max (FR)

Correspondence Address: YOUNG & THOMPSON, 745 SOUTH 23RD STREET 2ND FLOOR, ARLINGTON, VA, 22202

(21) Appl. No.: 10/474,809

(22) PCT Filed: May 15, 2002
(86) PCT No.: PCT/FR02/01634

(30) Foreign Application Priority Data
May 15, 2001 (FR) 01/06403

(51) Int. Cl. C08K 3/00

(52) U.S. Cl. 523/332

(57) ABSTRACT

The invention concerns a method for obtaining solid particles from at least a water soluble product, characterized in that it comprises steps which consist in: forming a solution of said product in an aqueous phase, producing an emulsion, or a micro-emulsion, consisting of said aqueous mixture and a polar organic phase, contacting said emulsion, or said micro-emulsion, with a fluid at supercritical pressure, or a liquefied gas, so that the latter extracts the organic phase and the water, thereby precipitating the formed solid particles of the water soluble product, and collecting the resulting formed particles.

The present invention relates to a method intended for the production of fine solid particles from a water soluble product.

It is known that numerous industries employ solids in pulverulent form and such powders are either in the form of simple particles constituted solely by one component, or in the form of complex particles constituted either by an active principle dispersed within a suitable coating or by a core made of a certain material and a coating made of another material.

The pharmaceutical industry, but also the cosmetics and agrochemical industry, require new formulations in order to improve the efficiency of certain molecules of therapeutic, dermatological or plant-protective interest. For example, means are sought for increasing the solubility in biological media of insoluble or very sparingly soluble active principles, in order to increase their bio-availability, to reduce the doses administered and therefore to reduce the secondary effects. Similarly, it is sometimes of interest to obtain a controlled dissolution within the tissues or biological fluids such as blood or lymph. To that end, either very dispersed forms of the active principles having a much more rapid speed of dissolution than the usual powders are in that case preferably used, or micro-capsules of so-called matricial structure type, sometimes also called micro-spheres, which are constituted by a mixture, which is as homogeneous as possible, of the particles of active principle within an excipient. Ideally, the active principle is literally dissolved within the excipient.

It is also sought to avoid the loss of biological activity which is due to the problems of instability in the aqueous media or during storage in the presence of oxygen, of humidity of the air or of light, or to effect an efficient protection of certain molecules which would be destroyed as soon as they are absorbed by the digestive enzymes. Different excipients are used with a view to solving these problems, without, however, making it possible to propose satisfactory solutions in numerous cases. The micro-capsules constituted by a “core” and a “peel” respond well to this need, and the micro-spheres with matricial structure may also be used to that end.

The interest of these structures is such that numerous methods of obtaining have been described and, for certain, are in the course of industrial exploitation. However, it will be noted that it is particularly difficult to manufacture such very fine powders, such micro-spheres or micro-capsules from bio-molecules and in particular proteins of therapeutic interest, by reason of the great fragility of these products of which denaturation is irreversible. In effect, it is known that, unlike the conventional chemical or biological products, proteins are complex and fragile edifices whose biological activity is closely connected with the three-dimensional conformation which may be given by the environment of the molecule, which brings about a generally irreversible destruction of its biological activity. This fragility is particularly great for numerous proteins of high therapeutic interest of which production is beginning to be carried out in accordance with the new biotechnologies, but of which the therapeutic implementation is proving to be extremely delicate.

It is known in the prior state of the art that supercritical fluids, and particularly supercritical carbon dioxide, are widely used for the purpose of making very fine powders which are capable of dissolving very rapidly or of being usable by ingestion by the respiratory passages. Supercritical fluids are also used for the purpose of obtaining complex particles consisting in mixtures of different morphologies of the active principle and of an excipient, such as micro-spheres or micro-capsules.

The different states of a fluid and its properties in each of these states will firstly be recalled. It is known that bodies are generally known in three states, namely solid, liquid or gaseous and that one passes from one to the other by varying the temperature and/or the pressure. Apart from the solid state, there exists the liquid state and the gaseous state, separated by the vaporization/condensation curve, but it is known that there exists a point beyond which one can continuously pass from the liquid state to the state of gas or of vapour without passing through a boiling or, inversely, by a condensation. This point is called the critical point CP.

The supercritical state is characterized either by a pressure and a temperature respectively higher than the critical pressure and temperature in the case of a pure body, or by a representative point (pressure, temperature) located beyond the envelope of the critical points represented on a diagram (pressure, temperature) in the case of a mixture. In that case, it presents, with respect to very numerous substances, a high solvent power with no possible comparison with that which it presents having regard to this same fluid when it is in the state of compressed gas.

The same applies to so-called “sub-critical” liquids, i.e. liquids which are in a state characterized either by a pressure higher than the critical pressure and by a temperature lower than the critical temperature in the case of a pure body, or by a pressure higher than the critical pressures and a temperature lower than the critical temperatures of the components in the case of a mixture (cf. on this subject the article by Michel PERRUT—Les Techniques de l'Ingénieur (Engineering Techniques) “Extraction by supercritical fluid, J 2 770-1 to 12, 1999”). A liquefied gas may also be used, i.e. a gaseous fluid under conditions of atmospheric pressure and of temperature close to ambient, maintained in the liquid state at a temperature lower than its critical temperature and, a fortiori, than its boiling temperature at the pressure in question. The considerable and modulatable variations of the solvent power of the fluids at supercritical pressure and of the liquefied gases are, moreover, used in numerous methods of extraction (solid/fluid), of fractionation (liquid/fluid), of analytic or preparative chromatography, of treatment of materials (ceramics, polymers) and of generation of particles. Chemical or biochemical reactions are also effected in such solvents.

It should be noted that the physico-chemical properties of carbon dioxide as well as its critical parameters (critical pressure: 7.4 MPa and critical temperature: 31° C.) make it the preferred solvent in numerous applications, all the more so as it does not present any toxicity and as it is available at very low price in very large quantities. Other fluids may also be used under similar conditions, such as nitrogen protoxide, light hydrocarbons having two to four carbon atoms, and certain halogenated hydrocarbons.

It will be noted that water is generally very sparingly soluble in the fluids at supercritical pressure and the liquefied gases conventionally used, and in particular in carbon dioxide under high pressure within which the water is soluble only at a rate of 1 to 3 g/kg between 25° C. and 50° C. This leads to a considerable limitation in the application of the methods aiming at obtaining particles when the products to be treated can be placed in solution only in aqueous media, such as bio-molecules and particularly proteins and peptides.

It will also be noted that, on the contrary, water may be placed in solution in carbon dioxide, at significant concentrations reaching several tens of grams per kilogram, when the carbon dioxide has a polar co-solvent added thereto which will perform the role of entraining agent of the water. Alcohols and more particularly ethanol are thus principally used to that end.

Hereinafter and for convenience of language, a fluid taken to a pressure greater than its critical pressure, i.e. either a supercritical fluid proper, or a so-called sub-critical liquid as defined hereinabove, will be called fluid at supercritical pressure Similarly, a liquid constituted by a compound which is in the gaseous state at atmospheric pressure and at ambient temperature, which is taken to a temperature lower than its boiling temperature at the pressure in question, will be called liquefied gas.

According to tens of scientific publications and Patents, it is known that micro-particles with a granulometry generally included between 1 μm and 10 μm, and nano-particles with a granulometry generally included between 0.1 μm and 1 μm, can be obtained by using methods employing supercritical fluids, such as the method known under the name of RESS consisting in allowing to expand, very rapidly at low pressure, a solution of the product to be atomized in a supercritical fluid, or the anti-solvent method known under different names SAS, SEDS, PCA, ASES, consisting in pulverizing a solution of the product to be atomized in an organic or aqueous solvent within a stream of fluid in supercritical state.

These methods make it possible to obtain a powder of very fine particles dispersed within a gaseous stream at low pressure (RESS method), as described for example in U.S. Pat. No. 4,582,731, or at high pressure (SAS method) as described for example in U.S. Pat. No. 5,707,634, EP-A-0 322 687 and U.S. Pat. No. 5,043,280.

However, the person skilled in the art knows that the RESS method is not applicable to the majority of the molecules soluble in water, like the bio-molecules, as they are not at all soluble in the fluids at supercritical pressure and in the liquefied gases. Similarly, the methods of anti-solvent type are adapted to the treatment of active principles soluble in the organic solvents, and can be employed only with difficulty when the product to be treated can be dissolved only in water. In effect, water being virtually insoluble in the fluids at supercritical pressure and in the liquefied gases, an anti-solvent fluid must in that case imperatively be used, constituted by a fluid at supercritical pressure or by a liquefied gas to which a polar co-solvent, generally an alcohol, has been added, which will perform the role of entraining agent and allow the elimination of the water by the fluid, this at the cost of a considerable complexity and very high treatment costs.

The same applies to the methods described in U.S. Pat. No. 5,639,441, according to which an aqueous solution of the product is placed in contact with a fluid at supercritical pressure then is rapidly decompressed to atmospheric pressure, generating an aerosol of droplets of aqueous solution of the product which will produce a dry powder during elimination of the water from this fluid. In fact, this method is of the drying by atomization type, generally called spray-drying, requiring a considerable supply of heat to cause the water to pass from the liquid phase to the gaseous phase since the fluid thus decompressed presents no solvent power with respect to water.

It will be noted that the experimental results presented up to the present time have been obtained only on a laboratory scale where the heat transfers are very easy to effect since the required heat flows are very low, while, on the contrary, real difficulties of implementation appear when implementing on an industrial scale, the method thus described in that case not appearing to contribute a significant improvement with respect to the conventional method of drying by atomization of which the limits are well known as it is question of elaborating fine powders of heat-sensitive bio-molecules.

A recent article (H. Zhang, J. Lu, B. Han, “Precipitation of lyzozyme solubilized in reverse micelles by dissolved CO₂”, Journal of Supercritical Fluids, 20, 2001, p. 65-71), described the principle of an original method for obtaining protein powder from a reverse micellar solution of this protein within an organic solvent, founded on the selective precipitation of the protein by contact of the micellar solution with carbon dioxide under pressure, the water remaining in micellar solution in the solvent in question. Apart from the fact that this article describes only a principle and not a method for carrying out this principle, it will be noted that the protein powder thus prepared is apparently impregnated with residual water and with organic solvent, rendering its subsequent use problematic, unless it undergoes a subsequent treatment of purification.

Several methods aiming at generating micro-spheres in accordance with the anti-solvent principle, particularly Patents EP-A-0 322 687 and U.S. Pat. No. 5,043,280, or micro-capsules by using a fluid at supercritical pressure, a compressed gas or a liquefied gas, have been described in Patents and Patent Applications EP-A-0 322 687, WO-95/01221, WO-96/00610, EP-A-0 706 821, FR-A-2 753 639, FR-00.00185, EP-A-0 744 992, WO-98/15348 and FR-00.13393. Patents EP-A-0 322 687 and U.S. Pat. No. 5,043,280 describe a family of methods making it possible to prepare micro-spheres by placing a liquid solution of the active principle and of the excipient in contact with a supercritical fluid, applying, without naming it, the anti-solvent concept. It will be noted that these Patents do not claim the preparation of particles of pure products, but solely the preparation of complex particles of micro-sphere type.

Another method, described in Patents EP-A-0 706 821 and WO 98/15348, is based on the solution of the coating agent in the fluid at supercritical pressure. The person skilled in the art knows that the majority of the coatings used for shaping micro-capsules are insoluble in such fluids, which considerably limits the practical scope of this method.

A fortiori, the method described in several articles by P. Debenedetti's team (of which the following will be cited by way of example: P. Debenedetti, J. W. Tom, S. D. Yeo, G. B. Lim “Application of Supercritical Fluids for the Production of Sustained Delivery Devices”, Journal of Controlled Release, 24, 1993, 27-44), consisting in pulverizing a solution of the coating agent and of the active principle in the fluid at supercritical pressure, has still much more limited applications.

In order to avoid these limitations, several Patents, including Patents and Patent Applications EP-A-0 322 687, WO 95/01221 and WO 96/00610, describe the elaboration of micro-capsules or of micro-spheres in accordance with the concept of the anti-solvent method. This method involves the placing of the coating agent and of the active principle in solution in one or more organic or aqueous solvents, of which the necessary dissolution in the fluid at supercritical pressure will inescapably involve the use of at least one organic solvent or co-solvent, with the drawbacks that this involves: Considerable problems for recovery of the solvent and for purification of the micro-capsules obtained, difficulty, if not impossibility, of effecting encapsulation of bio-molecules such as proteins, of which the majority are irreversibly denatured upon contact with an organic solvent.

Another method, described in Patent FR-A-2 753 639, consists in effecting the coacervation of the coating agent initially dissolved in an organic solvent within which the particles to be coated are maintained in dispersion, said coacervation being provoked by an anti-solvent effect caused by the dissolution of a supercritical fluid or of a liquefied gas in said organic solvent. The recovery of the capsules obtained is effected after complete extraction of the organic solvent by a stream of supercritical fluid or of liquefied gas, then decompression of the recipient in which the encapsulation was effected. Therefore, this method likewise presents the drawback of necessitating the use of an organic solvent within which the particles of active agent will be dispersed.

The same applies for the implementation of certain Claims of French Patent Application No.00.00185 describing a method of collection and of encapsulation of fine particles generated by a method employing a fluid at supercritical pressure, according to which said particles are collected by washing the fluid within which they were generated by a solution of a coating agent which will precipitate on the particles and constitute micro-capsules due to the oversaturation of coating agent of said solution, caused by the interaction between said solution and the fluid transporting the particles. Such is not the case of certain arrangements of French Patent Application No. 00.00185 already mentioned, when the coating agent is dissolved in water, which, however, is rarely possible to carry out.

A very different method is described in European Patent EP-A-0 744 992, in accordance with a concept generally called “PGSS” (“Particles obtained from Gas Saturated Solutions”). This method consists in dissolving a compressible fluid in the substance to be pulverized until a solution saturated with fluid if formed, then in decompressing this solution so that, on the one hand, it is pulverized into fine droplets and, on the other hand, the cooling resulting from this decompression induces the solidification of the initial substance in the form of fine solid particles. This Patent also claims the production of micro-spheres constituted by a homogeneous mixture of two or more compounds which are initially mixed in the form of a homogeneous solution.

In very similar manner, certain arrangements of Patent Application WO-98/15348 describe the application of the preceding concept to the manufacture of micro-capsules constituted by particles of an active agent which are encapsulated in a polymer, using a fluid at supercritical pressure which, on dissolving in the polymer, liquefies it at a temperature lower than the melting temperature of the polymer and allows the suspension of the particles of the active agent within this liquid phase itself saturated with supercritical fluid. This suspension is then allowed to expand to atmospheric pressure with formation of micro-capsules due to the solidification of the polymer around the particles of active agent.

American U.S. Pat. No. 5,399,597 will also be mentioned, which describes a method for producing paint in powder form according to which a mixture comprising a polymer, a cross-linking agent and possibly other components entering in the conventional composition of a paint (pigments, fillers), with carbon dioxide in the supercritical state, is produced in a first, mechanically stirred recipient, this mixture being taken to adequate temperature and pressure in order to obtain, after partial or total expansion of this mixture in a second recipient maintained at a pressure clearly lower than that of the first, a solid powder constituted by an intimate mixture of the different initial solid constituents. These particles are therefore of a structure similar to that of the micro-spheres defined hereinabove. It will be noted that this method uses carbon dioxide at supercritical pressure and that the temperature of implementation of the mixture in the first recipient is generally close to that of melting or of vitreous transition of the polymer.

As for French Patent No. 00.09437, it describes the preparation of micro-capsules of active principle in a fluid compressed to a pressure lower than its critical pressure which, dissolving in the excipient, will make it possible to effect a homogeneous suspension of fine particles of active principle, which suspension will then be pulverized by rapid expansion.

Finally, German Utility Model DE-A-1990 4990 discloses a method intended for the formation of sub-micronic particles from a colloidal dispersion of a product in a solvent, which is partially extracted by a fluid at supercritical pressure. In such a method, which is very different from the method according to the invention, at no moment is the product dissolved in an aqueous phase, and at no moment is made a water/oil emulsion of this aqueous solution in a polar organic phase.

The present invention has for its object to propose a method for elaborating very fine powders, micro-spheres or micro-capsules, with a diameter generally smaller than 50 μm, and often smaller than 20 μm, from, in particular, biomolecules and particularly from proteins.

The present invention thus has for its object a method for obtaining solid particles from at least one water soluble product, characterized in that it comprises the steps consisting in:

forming a solution of said product in an aqueous phase,

producing an emulsion, or a micro-emulsion, consisting of this aqueous mixture and a polar organic phase,

contacting this emulsion, or this micro-emulsion, with a fluid at supercritical pressure, or a liquefied gas, so that the latter extracts the organic phase and the water, thereby provoking precipitation of the constituted solid particles of the water soluble product,

collecting the particles thus formed.

In a particularly advantageous variant of the invention, the aqueous phase and/or the organic phase may contain at least one coating agent. This coating agent may be constituted by at least one lipid of the type used in the pharmaceutical or cosmetic industries or by at least one polymer of the type used in the pharmaceutical or cosmetic industries.

In addition to carbon dioxide which is preferred in numerous applications, the fluid at supercritical pressure, or the liquefied gas, may also be nitrogen protoxide or dimethylether or a mixture of these gases. As for the polar organic solvent, it may be an alcohol having between 3 and 10 carbon atoms, and preferably between 4 and 7 carbon atoms, or an ester formed from a carboxylic acid and from an alcohol having in total between 5 and 12 carbon atoms, or a ketone having between 5 and 8 carbon atoms.

The method may be carried out by effecting:

a continuous supply in an enclosure, on the one hand, of the fluid at supercritical pressure or of the liquefied gas and, on the other hand, of the emulsion or of the micro-emulsion, and

a continuous drawing-off from this enclosure of the fluid containing the particles.

In a particularly advantageous variant, if it is desired to elaborate particles of very small diameter, less than 1 μm, in the second step of one of the methods described hereinabove, a micro-emulsion of the aqueous solution within the organic phase will be prepared in accordance with the conventionally used techniques. The size of the globules of aqueous phase being very small in such a micro-emulsion, this will result in the generation of particles which are much finer than when a conventional emulsion is treated.

In another variant of the invention, a double emulsion of oil/water/oil type will be prepared, always with a view to obtaining a very great dispersion of the aqueous phase upon contact with the fluid at supercritical pressure or the liquefied gas, so as to generate particles of very small diameter.

This invention is particularly advantageous when it is desired to obtain fine powders of bio-molecules and in particular proteins, or to prepare micro-capsules or micro-spheres incorporating such bio-molecules.

Unlike the methods of the prior state of the art, the present invention makes it possible to use a wide variety of active agents and of water soluble excipients, and of coating agents. Moreover, it makes it possible easily to obtain sterile particles as the initial aqueous solution is sterile and the recovery of the particles is effected in accordance with the usual rules of sterility, the method itself being intrinsically sterile and in no way increasing the biological charge of the products employed. Moreover, carbon dioxide under pressure being a biocide, it can, when used in accordance with the present invention, but facilitate the sterility of the operation, and even destroy the micro-organisms possibly present in the fluids by accident.

These advantages become meaningful when the atomization of bio-molecules and particularly of proteins, which may thus be obtained in the form of micronized dry powder, from an aqueous solution in the presence of stabilization agents, is considered. In effect, such proteins, mixed with stabilization agents, cannot be placed in solution within an organic solvent as described in U.S. Pat. No. 5,707,634, EP-A-0 322 687 and U.S. Pat. No. 5,043,280.

According to the invention, the active principle is placed in aqueous solution, possibly the presence of the stabilization agents required for ensuring a good stability of the molecule and of its three-dimensional conformation. This aqueous phase then has a polar organic solvent added thereto, chosen to make it possible to obtain an emulsion easily which, if necessary, may be stabilized by having one or more surface-active agent(s) added thereto, chosen as a function of the nature of the polar organic solvent used, in accordance with well established knowledge in the matter and respecting the possible constraints associated with the use of the product, in particular concerning toxicity and regulations. This emulsion is then placed in contact with a fluid at supercritical pressure or a liquefied gas which will extract the organic solvent and the water due to the effect of entrainment associated with the presence of this solvent dissolved in the fluid. This is why the emulsion should be dosed so that the water can be entirely entrained by the fluid in the presence of the organic solvent used. The mass of aqueous phase placed in emulsion will preferably be included between 1% and 30% of the mass of the organic solvent, this is why it will in that case be chosen to employ a water/oil emulsion. A dry powder will thus be obtained, constituted by particles of the product possibly accompanied by the stabilization agents present in the aqueous phase, and by traces of surface-active agent if it was used for stabilizing the emulsion.

It will be understood that the choice of the organic solvent is of prime importance since it must at the same time make it possible to produce a stable emulsion with an aqueous phase, be very soluble in the fluid at supercritical pressure or the liquefied gas, and perform the role of entraining co-solvent to allow the extraction of the water. Moreover, it must not present unacceptable risks of toxicity although the method according to the invention makes it possible to reduce the residual concentration of this solvent in the particles obtained at very low levels acceptable for the majority of the solvents in the pharmaceutical, cosmetic or veterinary applications. Numerous solvents present these properties, and it so happens that certain alcohols, esters and ketones respond particularly well to these criteria. The alcohols having between 3 and 10 carbon atoms, preferably between 4 and 7 carbon atoms, the esters formed from carboxylic acids and alcohols having in total between 5 and 12 carbon atoms, ketones having between 5 and 8 carbon atoms, will thus be cited in non-limiting manner.

Various forms of embodiment of the present invention will be described hereinafter, by way of non-limiting example, with reference to the accompanying drawings, in which:

FIG. 1 is a schematic view of an installation for carrying out the method according to the invention.

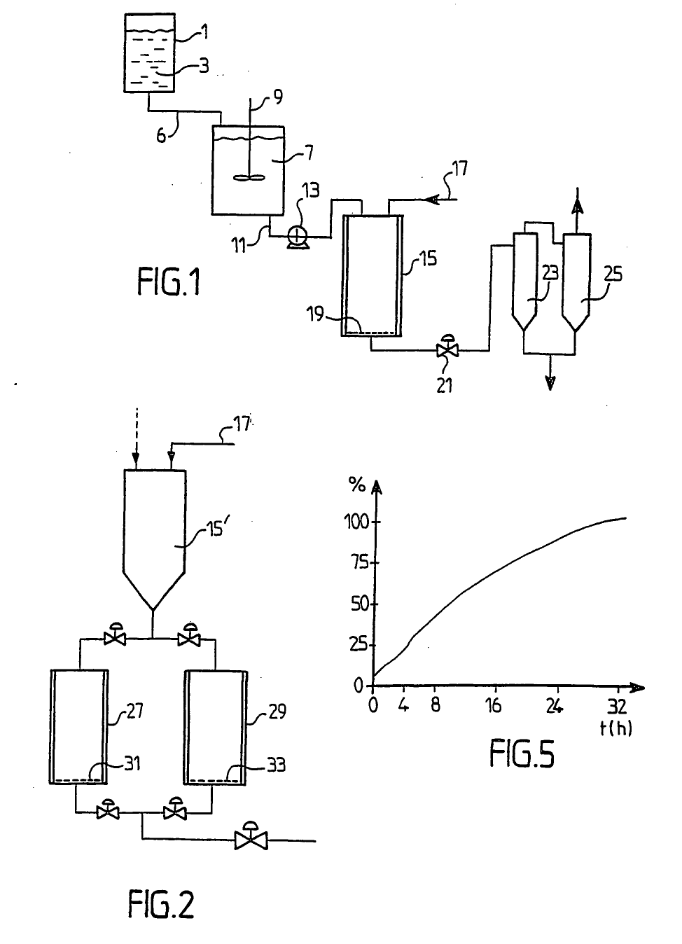

FIG. 2 is a schematic view of a variant embodiment of the installation shown in FIG. 1.

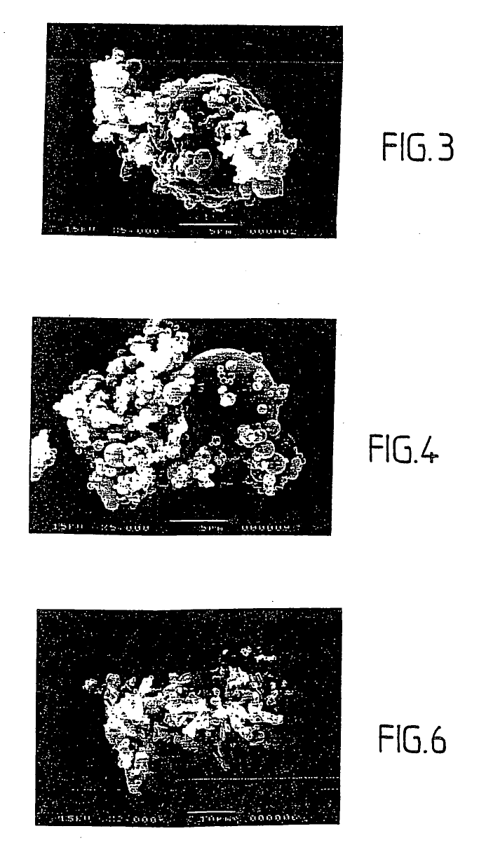

FIG. 3 is a photograph of a particle of BSA (Bovine Serous Albumin) obtained by the method according to the invention.

FIG. 4 is a photograph of a particle of BSA stabilized with mannitol obtained by the method according to the invention.

FIG. 5 is a graph representing the curve of salting out as a function of time of a protein.

FIG. 6 is a photograph of a particle of valine obtained by the method according to the invention.

FIG. 1 shows an installation for carrying out the method according to the invention. This installation comprises a mixing vat 1 containing water 3 in which the active agent is dissolved so as to place the latter in solution. The vat 1 communicates via a conduit 6 with a mixer vat 7 which contains an organic solvent, possibly stabilized by the addition of an appropriate surface-active agent. The solution of active principle is conducted into the vat 7 and the whole is emulsified by means of a stirrer 9. The contents of the mixer vat 7 are conducted via a conduit 11 and a pump 13 into a reactor 15 under pressure which, furthermore, receives, via a conduit 17, a fluid at supercritical pressure or a liquefied gas. This fluid, taken to the desired temperature and pressure, rapidly extracts the solvent and the water contained in the emulsion and provokes the precipitation of the active agent in the form of particles which are entrained by the stream of fluid from which they may be collected on a filter 19, which is disposed in the bottom of the reactor 15 and through which the fluid leaving the latter percolates. According to the technique known in the domain of extraction by fluid at supercritical pressure, the stream of fluid laden with organic solvent and with water is then allowed to expand in a valve 21 and the liquid phase constituted by organic solvent and water is collected in separators 23 and 25, the compressed gas thus being rid of this liquid phase then being recycled.

In a variant of the invention which is particularly interesting from the economic standpoint, and which is schematically shown in FIG. 2, a reactor 15′ with conical bottom, having no filter, is used, and the flow of particle-laden fluid is directed towards one or the other of two collecting recipients 27 or 29 which are each provided with a basket 31, 33 closed at its base by a filtration element. The enclosure 15′ may thus be continuously supplied with the fluid at supercritical pressure or the liquefied gas, on the one hand, and with the emulsion on the other hand, the fluid laden with particles may be continuously drawn off and these latter collected on one of the filtration elements while the particles already collected on the other element are recovered, this after depressurization and opening of the collecting recipient or in accordance with a method such as the one described in French Patent Application No. 99.15832.

### EXAMPLES OF EMBODIMENT

Examples of embodiment are presented hereinafter in order to illustrate the method according to the invention.

The equipment for generating particles and for collecting the micro-capsules shown in FIG. 1, which was of standard size, was used for carrying them out. It used carbon dioxide at a service pressure of 30 MPa and a temperature range going from 0° C. to 80° C. The reactor 15 under pressure was of cylindrical shape, with a diameter of 0.10 m and a total volume of 4 litres. It comprises a double envelope traversed by a heat exchange fluid making it possible to maintain the temperature of the assembly at the desired value. This reactor comprised a basket constituted by a cylinder with an outer diameter of 9.2 cm, which was open at its upper part and closed at its lower part by a filter 19 constituted by a disc of sintered metal coated with a filtering membrane of glass fibers with a porosity of 1 μm. The fluid was introduced via an orifice formed on a flange in the upper part of the reactor 15. The separators 23 and 25 were constituted by cyclonic chambers with a volume of 200 mL.

### Example 1

Very fine particles of albumin of BSA (“Bovine Serous Albumin”) type were produced with the aid of the equipment thus described.

To that end, a solution of BSA in demineralized water at 40 mg/mL of BSA was prepared. The emulsion was made at atmospheric pressure at 20° C. by rapid stirring of a mixture of 10 mL of this solution, 80 mL of n-pentanol and 1 g of surface-active agent constituted by “Tween 80” (polyoxyethylenesorbitan oleate). This emulsion was then introduced in the reactor 15 at the rate of 3 mL/min, through a nozzle of 500 μm diameter in a flow of 15 kg/hr of carbon dioxide taken to a pressure of 20 MPa and to 40° C. At the end of operation, 0.7 g of a dry powder of slightly yellow colour was collected, of which a sample was observed in a scanning electron microscope, as represented on the photo of FIG. 3. It is thus observed that the particles obtained are spherical, slightly agglomerated with a granulometric distribution included between 0.5 μm and 3 μm.

### Example 2

The test made in Example 1 was reproduced under similar conditions, except that mannitol was used for stabilizing the protein.

A solution in demineralized water at 36 mg/mL of BSA and at 4 mg/mL of mannitol was thus prepared. The emulsion was made at atmospheric pressure at 20° C., by rapid stirring of a mixture of 10 mL of this solution, of 80 mL of n-pentanol and 1 g of surface-active agent constituted by “Tween 80”. The placing in contact with carbon dioxide was effected as described previously. At the end of operation, 0.65 g of a dry powder of slightly yellow colour was collected, of which a sample was observed in a scanning electron microscope as shown in the photo of FIG. 4. It has been ascertained that the particles thus obtained are spherical, hardly agglomerated, and the majority have a diameter included between 0.5 and 3 μm.

Moreover, analysis by gaseous phase chromatography of the pentanol content of the particles composing this powder led to a content of 0.1% by mass.

### Example 3

The test made in Example 1 was reproduced under similar conditions, except that a coating agent called “Eudragit L100” was dissolved in the organic solvent, said agent constituted by an acrylic polymer frequently used as pharmaceutical excipient. A solution in n-pentanol of 10 mg/mL of “Eudragit L100” was prepared and the procedure was as in Example 1. At the end of operation, a white powder, non-agglomerated, constituted by particles with a diameter included between 1 μm and 5 μm was obtained.

Measurements relative to the placing in solution of the protein in a pH 4 buffer were conducted at 37° C. with monitoring of the concentration in the water by UV spectrophotometry. The curve of salting out of the protein as a function of time is presented in FIG. 5, showing that the protein was effectively encapsulated within the coating agent without immediate effect of salting out during the contact with the aqueous phase. On the contrary, the salting out of the protein was progressive and very regular for 32 hours.

### Example 4

The test made in Example 1 was reproduced under similar conditions, using a protein called lactase.

At the end of operation, 0.67 g of fine, yellowish powder was collected. Measurements relative to the biological activity were conducted in accordance with the protocol generally used for measuring the enzymatic activity of the lactases. The reaction employed is the hydrolysis of O-nitrophenyl-galactopyranoside (ONPG) into O-nitrophenol and D-galactose, the production of the O-nitrophenol being monitored by spectrophotometry at 420 nm. A comparison of the activities of the protein before and after treatment did not show any significant variations, thus indicating that the method does not alter the biological activity thereof.

### Example 5

The test carried out in Example 1 was reproduced under the same conditions, using an amino acid, namely valine.

A solution in demineralized water at 60 mg/mL of valine was prepared. The emulsion was made at atmospheric pressure at 20° C. by rapid stirring of a mixture of 20 mL of this solution, of 80 mL of n-pentanol and 1 g of surface-active agent constituted by “Tween 80”. The placing in contact with carbon dioxide was effected under the same conditions as previously. At the end of operation, 1.02 g of a dry powder, white in colour, was collected, of which a sample was observed in a scanning electron microscope as shown in the photograph of FIG. 6. It was thus ascertained that the particles obtained are agglomerated crystals, the majority having a diameter of the order of some microns.

Moreover, the analysis by gaseous phase chromatography of the n-pentanol content of the particles composing this powder led to a content of 0.1% by mass.

### Example 6

The test made in Example 1 was reproduced under the same conditions, using a sugar, namely sorbitol.

A solution in demineralized water at 250 mg/mL of “SORBITOL” was thus prepared. The emulsion was obtained at atmospheric pressure at 20° C. by rapid stirring of a mixture of 10 mL of this solution, of 90 mL of n-butanol and 1 g of surface-active agent constituted by “Tween 80”. The placing in contact with carbon dioxide was effected under the same conditions as previously. At the end of operation, 2.1 g of a dry powder, white in colour, were collected, of which a sample was observed in a scanning electron microscope. It was ascertained that the particles obtained were fibrils of which the majority presented a diameter of the order of 1 μm and a length of the order of 10 μm to 20 μm.

1. Method for obtaining solid particles from at least one water soluble product, characterized in that it comprises the steps consisting in:
forming a solution of said product in an aqueous phase,
producing an emulsion, or a micro-emulsion, consisting of this aqueous mixture and a polar organic phase,
contacting this emulsion, or this micro-emulsion, with a fluid at supercritical pressure, or a liquefied gas, so that the latter extracts the organic phase and the water, thereby provoking precipitation of the constituted solid particles of the water soluble product,
collecting the particles thus formed.

2. Method according to claim 1, characterized in that the aqueous phase and/or the organic phase contains in solution at least one coating agent.

3. Method according to one of claims 1 or 2, characterized in that the emulsion or the micro-emulsion is of the water/oil type.

4. Method according to one of claims 1 or 2, characterized in that the emulsion or the micro-emulsion is of the oil/water/oil type.

5. Method according to one of the preceding claims, characterized in that the fluid at supercritical pressure, or the liquefied gas, is carbon dioxide.

6. Method according to one of claims 1 to 4, characterized in that the fluid at supercritical pressure, or the liquefied gas, is nitrogen protoxide.

7. Method according to one of claims 1 to 4, characterized in that the fluid at supercritical pressure, or the liquefied gas, is dimethylether.

8. Method according to one of claims 5 to 7, characterized in that the fluid at supercritical pressure is constituted by a mixture of at least two of the gases: carbon dioxide, nitrogen protoxide, dimethylether.

9. Method according to any one of the preceding claims, characterized in that the polar organic solvent is an alcohol having between 3 and 10 carbon atoms, and preferably between 4 and 7 carbon atoms, or an ester formed from a carboxylic acid and from an alcohol having in total between 5 and 12 carbon atoms, or a ketone having between 5 and 8 carbon atoms.

10. Method according to any one of the preceding claims, characterized in that the water soluble product is constituted by at least one active principle, of alimentary, pharmaceutical, cosmetic, agrochemical or veterinary interest.

11. Method according to one of claims 1 to 9, characterized in that the water soluble product is constituted by at least one protein, or by a mixture of this protein with a stabilization agent.

12. Method according to one of claims 2 to 11, characterized in that the coating agent is constituted by at least one polymer of the type used in the pharmaceutical or cosmetic industries.

13. Method according to one of claims 2 to 11, characterized in that the coating agent is constituted by at least one lipid of the type used in the pharmaceutical or cosmetic industries.

14. Method according to one of the preceding claims, characterized in that there is effected:
a continuous supply in an enclosure (15′), on the one hand, of the fluid at supercritical pressure or of the liquefied gas and, on the other hand, of the emulsion or of the micro-emulsion, and
a continuous drawing-off from this enclosure (15′) of the fluid containing the particles.
